(19) United States
(12) Patent Application Publication
(10) Pub. No.: US 2025/0103379 A1
(43) Pub. Date: Mar. 27, 2025

(54) CONTAINER MANAGEMENT METHOD AND APPARATUS BASED ON CLOUD PLATFORM

(71) Applicant: New H3C Technologies Co., Ltd., Hangzhou (CN)

(72) Inventor: Sheng LI, Beijing (CN)

(21) Appl. No.: 18/826,916

(22) Filed: Sep. 6, 2024

(30) Foreign Application Priority Data
Sep. 22, 2023 (CN) 202311240750.1

(51) Int. Cl. G06F 9/455; G06F 9/50

(52) U.S. Cl. CPC G06F 9/45558; G06F 9/5072

(57) ABSTRACT

The examples of the present disclosure provide a container management method and apparatus based on a cloud platform. The examples achieve real-time monitoring of various containers in the container cluster through the leader of the cloud platform cluster, realizing container management based on the cloud platform by using the cloud platform cluster in the stacked system to manage the container cluster. Furthermore, in the examples, in response to determining that the master in the container cluster is abnormal, in response to determining that any container detects abnormality in the cloud platform serving as a leader or in a link between this container and leader, this container will corporate with other containers in the container cluster to autonomously elect a master. In response to determining that the leader and the link between this container and leader is normal, the leader centrally controls the containers in the container cluster to elect the master. This achieves a dual-layer strategy for electing the master, which greatly improves the reliability of the stacked system.

### CROSS-REFERENCE TO RELATED APPLICATION

The present application claims the priority to Chinese Patent Application No. 202311240750.1 filed Sep. 22, 2023, which is incorporated herein by reference in its entirety.

### TECHNICAL FIELD

The invention relates to the field of network communication, in particular to a container management method and apparatus based on a cloud platform.

### BACKGROUND

Virtualization technology has the core idea that multiple physical apparatuses are connected together and necessary configurations are performed on the multiple physical apparatuses, then the multiple physical apparatuses automatically converge and virtualize into a single virtual apparatus (also known as a stacked system). FIG. 1 illustrates the Intelligent Resilient Framework (IRF) as an example of a stacked system. For ease of understanding, the various physical apparatuses in the stacked system may be referred to as member apparatuses of the stacked system. Using this virtualization technology, it is possible to aggregate the hardware resources and software processing capabilities of multiple physical apparatuses, achieve collaborative work, unified management, and uninterrupted maintenance of multiple physical apparatuses.

With the rapid popularity of container technology, various container applications are becoming increasingly widespread and deep, and how to combine the stacked system with containers is a pressing technical issue that needs to be addressed.

### SUMMARY

In view of this, the examples of the present disclosure provide a container management method and apparatus based on a cloud platform, to utilize a cloud platform cluster in a stacked system to manage container clusters and implement the container management method based on a cloud platform.

According to a first aspect of the examples of the present disclosure, it is provided a container management method based on a cloud platform applied to any member apparatus in a stacked system, the stacked system is obtained by stacking N member apparatuses, each of which is deployed with both a cloud platform and a container, cloud platforms on different member apparatuses in the stacked system form a cloud platform cluster, and containers on different member apparatuses in the stacked system form a container cluster, wherein the method comprises:

in response to determining that a local cloud platform acts as a follower in the cloud platform cluster, obtaining container cluster topology information from a cloud platform that is elected as a leader in the cloud platform cluster; in response to determining that the local cloud platform acts as the leader, sending the container cluster topology information to other member apparatuses;

With the local cloud platform acting as the leader, determining a container health level of a local container in the member apparatus based on a health indicator of a health status of the local container, and receiving health indicators of containers reported by other member apparatuses in the stacked system, then determining container health levels of the containers on the other member apparatuses based on the received health indicators, and issuing the container health levels to the other member apparatuses; or

With the local cloud platform acting as the follower, in response to determining that the local container is a slave container, slave, in the container cluster and a master container, master, election event in the container cluster is detected by the local container, then in response to determining that the leader or a link between this container and the leader is abnormal, sending an unicast election message to other containers participating in the election in the container cluster based on the container cluster topology information to obtain container health levels of the other containers, and then electing a master based on the container health level of the local container and the container health levels of the other containers; in response to determining that the leader in the cloud platform cluster is normal and the link between this container and the leader is normal, electing the master based on the leader's control, wherein in response to determining that the local container is elected as the master, the local container takes over an original master's work and notifies other slaves to stop the election, and in response to determining that the local container is elected as the slave, the local container continues to work as the slave.

According to a second aspect of the examples of the present disclosure, it is provided a container management apparatus based on a cloud platform, which is applied to any member apparatus in a stacked system, the stacked system is obtained by stacking N member apparatuses, each of which is deployed with both a cloud platform and a container, cloud platforms on different member apparatuses in the stacked system form a cloud platform cluster, and containers on different member apparatuses in the stacked system form a container cluster, wherein the apparatus comprises:
a topology unit 1101, which is to obtain container cluster topology information from a cloud platform that is elected as a leader in the cloud platform cluster in response to determining that a local cloud platform acts as a follower in the cloud platform cluster, and send the container cluster topology information to other member apparatuses in response to determining that the local cloud platform acts as the leader;
a health indicator unit 1102, which is to, with the local cloud platform acting as the leader, determine a container health level of a local container in the member apparatus based on a health indicator of a health status of the local container, and receive health indicators of containers reported by other member apparatuses in the stacked system, then determine container health levels of the containers the on other member apparatuses based on the received health indicators, and issue the container health levels to the other member apparatuses;
a management unit 1103, which is to, with the local cloud platform acting as the follower, in response to determining that the local container is a slave container, slave, in the container cluster and a master container, master, election event in the container cluster is detected by the local container, then in response to determining that the leader or a link between this container and the leader is abnormal, send an unicast election message to other containers participating in the election in the container cluster based on the container cluster topology information to obtain container health levels of the other containers, and then elect a master based on the container health level of the local container and the container health levels of the other containers; in response to determining that the leader in the cloud platform cluster is normal and the link between this container and the leader is normal, elect the master based on the leader's control, wherein in response to determining that the local container is elected as the master, the local container takes over an original master's work and notifies other slaves to stop the election, and in response to determining that the local container is elected as the slave, the local container continues to work as the slave.

According to a third aspect of the examples of the present disclosure, it is provided an electronic device, comprising:
a processor 1201 and a machine-readable storage media 1202, wherein the machine-readable storage media stores machine-executable instructions 1203 therein that can be executed by the processor;
the processor is to execute the machine-executable instruction to carry out the above methods.

According to a third aspect of the examples of the present disclosure, it is provided a machine-readable storage media that stores machine-executable instructions therein that can be executed by the processor;
the machine-executable instructions carry out carry out the above methods when executed by a processor.

The technical solutions provided by the examples of the present disclosure may include the following beneficial effects:

In the examples, real-time monitoring of each container in the container cluster is achieved through the Leader in the cloud platform cluster, enabling container management based on the cloud platform by utilizing the cloud platform cluster in the stacked system to manage the container cluster.

Furthermore, in the examples, in response to determining that the master in the container cluster is abnormal, a container with the largest health level is selected as the master container in the container cluster based on the health levels of containers, effectively avoiding the operating scenarios such as two master containers, a faulty master container, or a faulty slave container being represent in the network, thereby increasing the stability of the entire stacked system;
Further, in the examples, in response to determining that any container detects an abnormality in the cloud platform serving as the leader or the link between the container and the leader, the container will cooperate with other containers in the container cluster to autonomously elect the master; and in response to determining that the leader is normal and the link between the container and the leader is normal, the leader centrally controls the master election process within the container cluster, achieving a dual-layer strategy for electing the master and greatly improving the reliability of the stacked system.

Further, in the examples, in response to determining that any container detects an abnormality in the cloud platform serving as the leader or the link between the container and the leader, the unicast election message is sent to other containers participating in this election in the container cluster based on the container cluster topology information to obtain the container health levels of the other containers, rather than broadcasting the election message, thus avoiding network oscillation.

### BRIEF DESCRIPTION OF THE DRAWINGS

FIG. 1 is a schematic diagram of the stacked system network shown in the example of the present disclosure;

FIG. 2 is a schematic diagram of each cluster in the stacked system shown in the example of the present disclosure;

FIG. 3 is a schematic diagram of a method shown in the example of the present disclosure;

FIG. 4 is a schematic diagram of container topology construction shown in the example of the present disclosure;

FIG. 5 is a schematic diagram of container reporting shown in the example of the present disclosure;

FIG. 6 is a schematic diagram of dual-layer master election shown in the example of the present disclosure;

FIG. 7 is a schematic diagram of master election shown in the example of the present disclosure;

FIG. 8 is a schematic diagram of master election network provided in the example of the present disclosure;

FIG. 9 is a schematic diagram of state switching provided in the example of the present disclosure;

FIG. 10 is another schematic diagram of process 303 provided in the example of the present disclosure;

FIG. 11 is a structural diagram of an apparatus shown in the example of the present disclosure;

FIG. 12 is a hardware structure diagram of an apparatus shown in the example of the present disclosure.

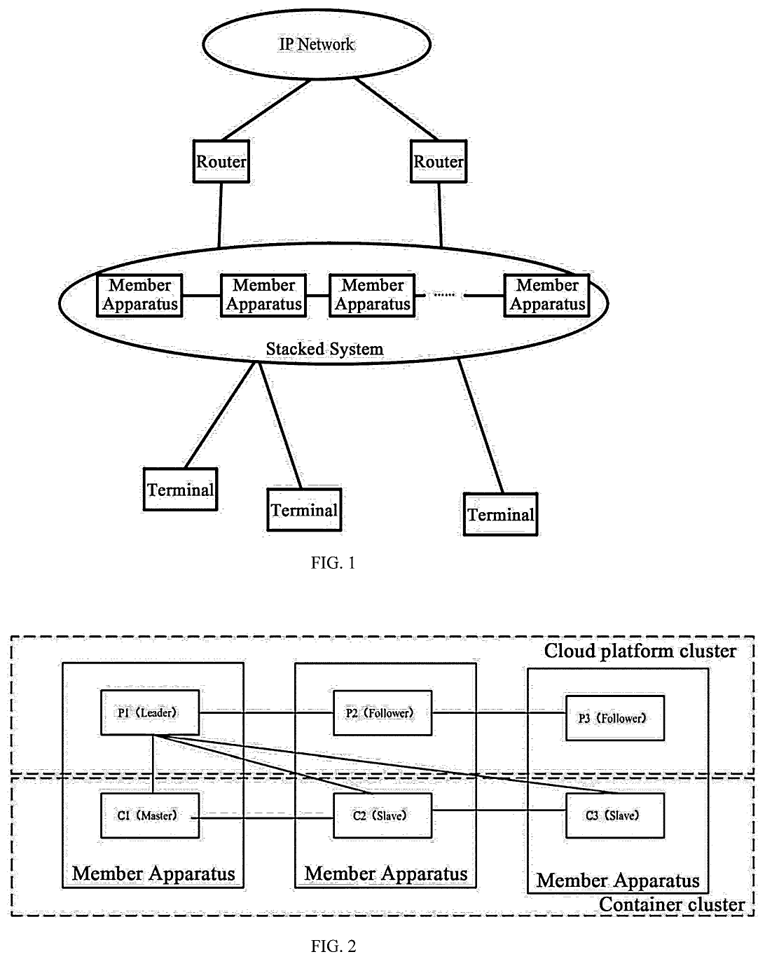

### DETAILED DESCRIPTION

Illustrative examples will be described in detail herein with the examples thereof illustrated in the drawings. When the following descriptions relate to the drawings, like numerals in different drawings represent like or similar elements unless stated otherwise. The implementations described in the following examples do not represent all implementations consistent with the present disclosure. On the contrary, they are merely examples of an apparatus and a method consistent with some aspects of the present disclosure described in detail in the appended claims.

The terminology used in the present disclosure is for the purpose of describing a particular example only, and is not intended to be limiting of the present disclosure. The singular forms such as “a,” ‘said,” and “the” used in the present disclosure and the appended claims are further intended to include multiple, unless the context clearly indicates otherwise. It is also to be understood that the term “and/or” as used herein refers to any or all possible combinations that include one or more associated listed items.

It is to be understood that although different information may be described using the terms such as first, second, third, etc. in the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “in response to determining.”

A description of the application scenarios provided by the examples of the present disclosure is provided:

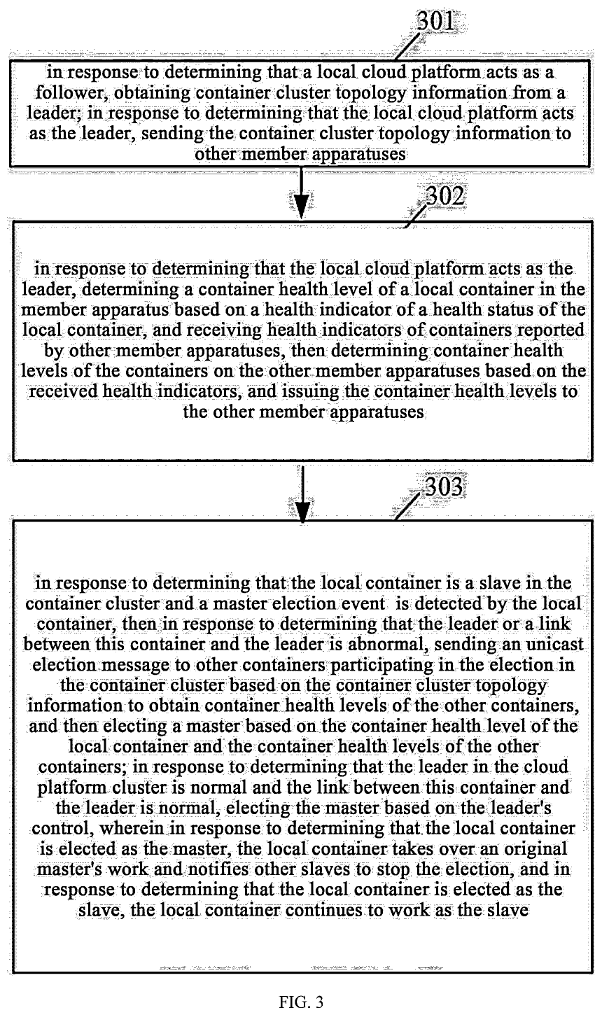

In this example, a cloud platform and a container runs on each member apparatus of the stacked system. For example, as shown in FIG. 2, three physical apparatuses form a stacked system, such as an Intelligent Resilient Framework (IRF) stacked system. Wherein P1, P2, and P3 represent the cloud platforms running on the three physical apparatuses, and C1, C2, and C3 represent the Comware V9 containers running on the three physical apparatuses.

In this example, the cloud platforms running on the physical apparatuses in the stacked system form a cloud platform cluster. Herein, one of the cloud platforms in the cloud platform cluster serves as a leader, and the remaining cloud platforms serve as followers. The role of each cloud platform in the cloud platform cluster may be elected through set algorithms such as the Raft algorithm, which will be described below by examples, and is not elaborated here. FIG. 2 provides an example of the cloud platform cluster and the roles of the cloud platforms in the cloud platform cluster.

In this example, the containers running on the physical apparatuses in the stacked system form a container cluster. Herein, one of the containers in the container cluster serves as the master container (master), and the remaining containers serve as slave containers (Slaves). The election of roles of the containers in the container cluster will be described by examples later, and is not elaborated here. FIG. 2 provides an example of the container cluster and the roles of the containers in the container cluster.

Based on the above description, a description of the methods provided by the examples of the present disclosure is as follows:

Referring to FIG. 3, FIG. 3 is schematic diagram of a method provided by the examples of the present disclosure, which is applied to any member apparatus in a stacked system. As shown in FIG. 3, the schematic diagram may comprise the following blocks:

Block 301, in response to determining that the local cloud platform acts as a follower, obtaining the container cluster topology information from the leader; in response to determining that the local cloud platform acts as a leader, sending the container cluster topology information to other member apparatuses.

As an example, a cloud platform in the cloud platform cluster may comprise a working component (Worker). Furthermore, at least one cloud platform comprises a management component (Manager). In this example, the cloud platform deployed with the manager may serve as a candidate leader and the cloud platform not deployed with the manager does not serve as a candidate leader. Based on this, in response to determining the leader in the cloud platform cluster leaves, other cloud platforms serving as candidates initiate a voting request as quick as possible. Any cloud platform casts a vote (choosing from the candidates) after receiving a voting request. In response to determining that one of the cloud platforms serving as candidates receives more than half of the votes, this cloud platform is determined as the leader, to replace the original leader to work.

In this example, the manager in the leader is responsible for managing the cloud platform cluster and uniformly processing the external configurations (also known as API processing). The Worker in the leader is responsible for managing a local container, for example, obtaining the running status of the local container and reporting it to the local manager. The Worker in the follower is responsible for managing a local container, such as obtaining the running status of the local container and reporting it to the manager in the leader, as well as receiving a container scheduling message issued by the manager in the leader, such as deploying a container and building a container cluster. It may be seen that this example uses the cloud platform to create containers and build a container cluster, eliminating the need for self-broadcasting to implement container stacking, effectively avoiding Layer 2 broadcast storms and network oscillations.

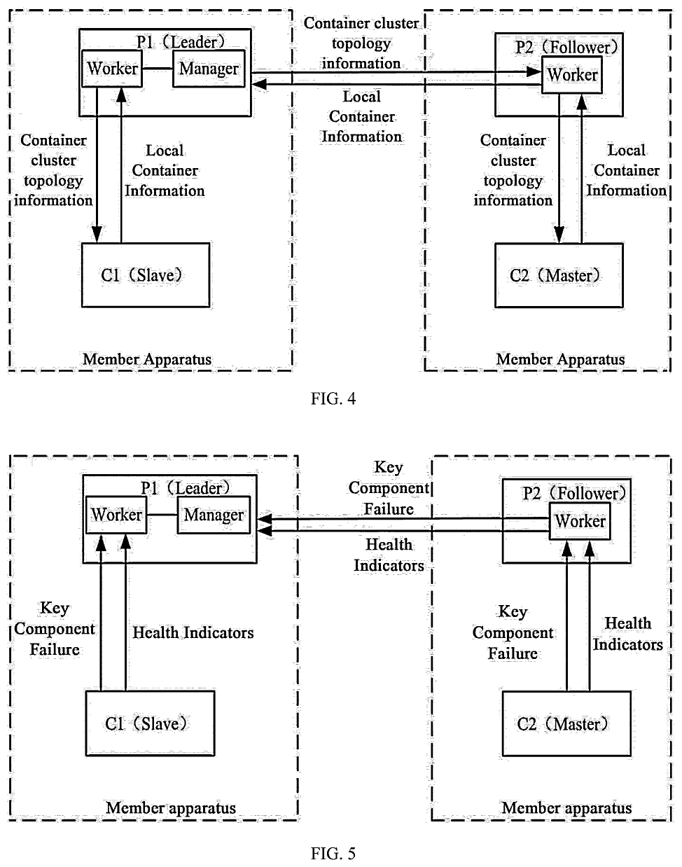

In this example, any container comprises a cloud platform agent component (Agent). The Worker of the cloud platform on any member apparatus of the stacked system communicates with the cloud platform Agent in the local container to obtain container information. Based on this, in block 301, in response to determining that the local cloud platform acts as a follower, obtaining the container cluster topology information from the leader may comprise: communicating with the leader through the local Worker to send local container information, i.e. container ID, member number, container MAC, etc., to the leader, enabling the leader to obtain the container information of containers on all member apparatuses in the entire stacked system (equivalent to obtaining the container cluster topology information by the leader); receiving the container cluster topology information issued by the leader through the local Worker. As a result, the container cluster topology information is obtained from the leader. FIG. 4 provides an example of a schematic diagram of issuance of the container cluster topology information.

Of course, in block 301, in response to determining that the local cloud platform acts as a leader, sending the container cluster topology information to other member apparatuses may comprise: sending the container cluster topology information to the Workers in the various followers through the local manager. A container topology change event may occur in the stacked system in which a container is added or deleted, and may be detected by the leader. The leader may further distribute the changed container cluster topology information to the Workers in the various followers through the local manager.

Block 302, in response of determining that the local cloud platform acts as a leader, determining a container health level of the local container on the member apparatus based on a health indicator of a health status of the local container, and receiving health indicators of containers reported by other member apparatuses, then determining container health levels of the containers on the other member apparatuses, and issuing the container health levels to the other member apparatuses.

In this example, the leader monitors the health indicators of the various containers in the container cluster through the local manager to intelligently manage the containers. FIG. 5 provides an example of a schematic diagram of reporting of health indicators of containers. For example, as shown in FIG. 5, in response to determining that the Worker in a cloud platform (comprising leader and follower) on each member apparatus monitors a health indicator, it reports the health indicator to the manager in the leader. As a result, the leader monitors the health indicators of the various containers in the container cluster through the local manager.

Optionally, in this example, the health indicator of the container is to reflect the business operation of the container. In some specific implementations, the health indicator may comprise: health indicators in the container environment, and health indicators in the container capacity. Any health indicator may be represented by a health indicator type and a health indicator value. Table 1 provides an example of a health indicator of a container from the dimensions of container environment and container capacity:

TABLE 1

| | | | Health |
|---|---|---|---|
| | Health Indicator | | Indicator |
| Dimension | Type | Meaning | Value |
| Container | Chip Jam | Chip Jam | 0 or 100 |
| Environment | CPU Port | CPU Port | 0 or 100 |
| | Board Status | Board Status | 0 or 100 |
| | Fan Status | Fan Status | 0 or 100 |
| | Temperature Status | Temperature Sensor | 0 or 100 |
| | | Status | |
| | Abnormal Reboot | Device Abnormal | 0 or 100 |
| | | Restart Times | |
| | | (>2 Times) | |
| Container | Arp Resource | Arp Entry Exceeding a | 70 or 100 |
| Capacity | | Threshold (Used/Total) | |
| | Mac Resource | Mac Entry Exceeding a | 70 or 100 |
| | | Threshold (Used/Total) | |
| | FIB Resource | Fib Entry Exceeding a | 70 or 100 |
| | | Threshold (Used/Total) | |
| | ND Resource | ND Entry Exceeding a | 70 or 100 |
| | | Threshold (Used/Total) | |
| | IPv4 Resource_L2 | IPv4 Two-layer | 70 or 100 |
| | | Multicast Entry | |
| | | Exceeding a Threshold | |
| | | (Used/Total) | |
| | IPv6 Resource_L2 | IPv6 Two-layer | 70 or 100 |
| | | Multicast Entry | |
| | | Exceeding a Threshold | |
| | | (Used/Total) | |
| | IPv4 Resource_L3 | IPv4 Three-layer | 70 or 100 |
| | | Multicast Entry | |
| | | Exceeding a Threshold | |
| | | (Used/Total) | |
| | IPv6 Resource_L3 | IPv6 Three-layer | 70 or 100 |
| | | Multicast Entry | |
| | | Exceeding a Threshold | |
| | | (Used/Total) | |
| | CPU Resource | Exceeding CPU | 70 or 100 |
| | | Resource Threshold | |
| | Memory Resource | Memory Resources | 70 or 100 |
| | | Exceeding a Threshold | |

In this example, the container environment health level may be determined based on the health indicators in various dimensions in the container environment, and the container capacity health level may be determined based on the health indicators in various dimensions in the container capacity. After that, the final container health level is determined based on the apparatus environment health level and the container capacity environment health level. In this example, the container health level reflects the true health status of the container. The higher the health level, the higher the priority, and the higher the probability of being elected as a master. In response of determining that the container health levels are the same, the container capacity represents the operating status of the container. The higher the container capacity, the higher the corresponding priority, and the higher the probability of being elected as a master.

Optionally, in this example, there are many ways to determine the apparatus environment health level based on the health indicators in various dimensions in the container environment in the specific implementation, for example, by selecting a health indicator with the minimum value in the container environment as the apparatus environment health level, which is not limited in this example.

Optionally, in this example, there are many ways to determine the container capacity health level based on the health indicators in various dimensions in the container capacity in the specific implementation, such as by selecting a health indicator with the minimum value in the container capacity as the container capacity health level, which is not limited in this example.

Optionally, in this example, the container health level may be calculated based on the following formula: Container Health Level=(Apparatus Environment Health Level+Capacity Health Level)/2. It should be noted that this is just an example of how to calculate the container health level, which is not a limitation.

Block 303, in response to determining the local container is a slave in the container cluster, and a master election event is detected by the local container, then in response to determining that the leader or a link between this container and the leader is abnormal, sending a unicast election message to other containers participating in the election in the container cluster based on the container cluster topology information to obtain container health levels of the other containers, and electing the master based on the container health level of the local container and the container health levels of the other containers; in response to determining that the leader in the cloud platform cluster is normal and the link between this container and the leader is normal, electing the master based on the control of the leader; wherein in response to determining that the local container is elected as the master, the local container takes over the original master's work and notifies other slaves to stop the election, and in response to determining that the local container is elected as the slave, it will continue to function in the role of slave.

In this example, the master election event may be triggered by faulty of a key component designated to a master in the container cluster, heartbeat detection timeout of a slave in the container cluster, etc. Optionally, heartbeat detection may be performed between a slave and a master in the container cluster, for example, the slave sending a heartbeat message to the master regularly, and in response to determining that no response is received from the master within the set time period from sending the heartbeat message, it is considered a heartbeat detection has timed out. As an example, once a slave detects a heartbeat detection timeout, the cloud platform Agent in the slave notifies the driver, which in turn notifies the apparatus management of insertion/removal events, thereby updating the membership presence information in the container cluster topology in a timely manner.

Optionally, in this example, the key component may be a functional component with a high real-time operation, and the faulty of the key component will affect the operation of the entire container. Optionally, the key component here may be CPU, plug board, etc. This example does not specifically limit it. Table 2 provides a situation of key component faulty:

TABLE 2

| | Key | | | | Faulty |
|---|---|---|---|---|---|
| | Component | | | Faulty | recovery |
| Num. | Faulty | Meaning | TLV | Impact | processing |
| 1 | Chip jam | Chip Jam | Normal | Container | Faulty |
| | | Timing | Abnormal | Faulty | Isolation |
| 2 | CPU port | CPU Port | Normal | Container | Faulty |
| | | Faulty | Abnormal | Faulty | Isolation |
| 3 | Board status | Plug Board | Normal | Container | Faulty |
| | | Faulty | Abnormal | Faulty | Isolation |
| | | (Used For | | | |
| | | Distributed | | | |
| | | Equipment) | | | |
| 4 | Stack | Link Faulty | Timeout | Container | Cluster |
| | heartbeat | Between | Recover | Cluster | Division |
| | | Different | Node | Division | isolation |
| | | Containers | Information | | such as |
| | | | | | primary |
| | | | | | board |
| | | | | | switchover |
| | | | | | and |
| | | | | | standby |
| | | | | | board |
| | | | | | removal, |
| | | | | | etc. |

Optionally, in this example, the container is equivalent to an operating system. In response of determining that a critical component, i.e. CPU, in the container fails, the cloud platform on the member apparatus where the container is located reports the faulty of the critical component to the manager in the leader through the local Worker in response to determining that the leader is normal. FIG. 5 provides an example of reporting the faulty of the critical component by the container. For example, in response to determining that the CPU in C2 fails, the Worker in P2 as a follower will report the CPU faulty to the manager in the leader. Once the manager in the leader receives the above critical component faulty, it will trigger a master election.

As an example, in response to determining that the container cluster is stacked in a star-shaped manner, then in response to determining that a slave in the container cluster detects a master election event, it will obtain the container health level of each of other containers based on the container cluster topology information, and then elect a master based on the container health level of the local container and the container health levels of the other containers.

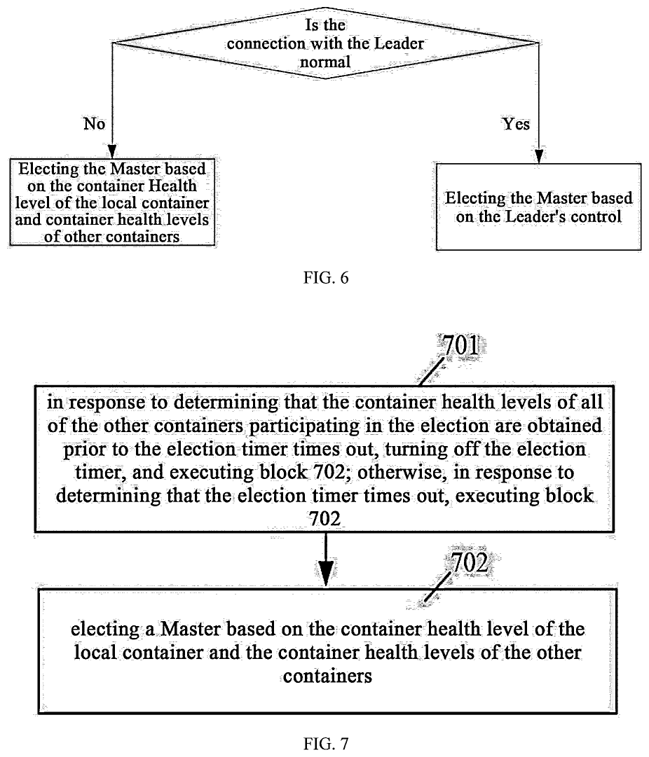

As an example, considering the container cluster is intended to be handled uniformly by the cloud platform, in response to determining that the leader is abnormal or the link between this container and the leader is abnormal, a unicast election message is sent to the other containers participating in this election based on the container cluster topology information to obtain the container health levels of the other containers, and then a master is elected based on the container health level of the local container and the container health levels of the other containers (also known as election of master by container itself, referred to as container inner-layer election of master); in response to determining that the leader in the cloud platform cluster is normal and the link between this container and the leader is normal, the master is elected based on the leader's control (also known as election of master under cloud platform's centralized control, referred to as cloud platform outer-layer election of Master.). Besides, in response to determining that the local container is elected as the master, the local container takes over the original master's work and notifies other slaves to stop the election. In response to determining that the local container is elected as the slave, the local container continues to work as a slave. For example, as shown in FIG. 6, in response to determining that the connection of this follower with the leader is normal, a master is elected based on the leader's control; otherwise, a master is elected based on the container health level of the local container and the container health levels of the other containers. This achieves a dual-layer master election strategy, improving the stability of the stacked system.

Optionally, heartbeat detection may further be performed between slaves in the container cluster, and other containers participating in this election may be containers connected to the slaves.

So far, the flow shown in FIG. 3 is completed.

It can be seen from the processes shown in FIG. 3 that, this example realizes real-time monitoring of various containers in the container cluster by the leader of the cloud platform cluster, achieving container management based on the cloud platform by using the cloud platform cluster in the stacked system to manage the container cluster.

Furthermore, in this example, in response of determining that the master in the container cluster is abnormal, a container with the largest health level is elected based on the health levels of containers as the master container in the container cluster, effectively avoiding the operating scenarios such as two master containers, faulty master container, or faulty slave container being present in the network, thereby increasing the stability of the entire stacked system.

Furthermore, in this example, in response to determining that any container detects an abnormality in the cloud platform serving as the leader or the link between this container and the leader, the container will cooperate with other containers in the container cluster to autonomously elect a master, and in response to determining that the leader is normal and the link between this container and the leader is normal, the leader centrally controls the master election process within the container cluster, achieving a dual-layer master election strategy, greatly improving the reliability of the stacked system.

Furthermore, in this example, in response to determining that any container detects an abnormality in the cloud platform serving as the leader or the link between this container and the leader, an unicast election message is sent to other containers participating in this election based on the container cluster topology information to obtain the container health levels of the other containers, rather than broadcasting the election message, thus avoiding network oscillation.

The following describes the block 303 in this example of electing a master based on the container health level of the local container and the container health levels of the other containers:

Optionally, in this example, in response to determining that any container determines that it is necessary to re-elect a master, the status of the local container will be switched to the election state, and an election timer will be started.

Based on this, block 303 of electing a master based on the container health level of the local container and the container health levels of the other containers may comprise the following flow as shown in FIG. 7:

Block 701: in response to determining that the container health levels of all of the other containers participating in the election are obtained prior to the election timer times out, turning off the election timer, and executing block 702. Otherwise, in response to determining that the election timer times out, block 702 is executed.

In this example, all other containers, with respect to the local container, participating in the election refer to containers whose heartbeat detection with the local container has not timed out, or containers that can be reached by the local container. In this example, all slaves further perform heartbeat detection with each other.

Block 702: Electing a master based on the container health level of the local container and the container health levels of the other containers.

Optionally, in this example, a master may be selected based on the following election decision criteria: the container with the optimal (i.e., the largest) container health level, is selected as a master.

In response to determining that the container health levels are the same, the container with the longest running time is selected as a master.

In response to determining that the running time is the same, the container which has a Mac address meeting the set requirements (such as, the minimum), is selected as a master.

Based on the above election decision criteria, block 702 may specifically comprise: electing a container with the largest container health level from the container health level of the local container and the container health levels of the other containers; in response to determining that values of container health levels of two or more containers are the same and largest, electing a container with the longest running time from the two or more containers; in response to determining that the number of the elected containers with the longest running time is greater than 1, selecting, from the elected containers with the longest running time, a container which has the bridge MAC address meeting the set requirements as the master.

So far, the flow shown in FIG. 7 is completed.

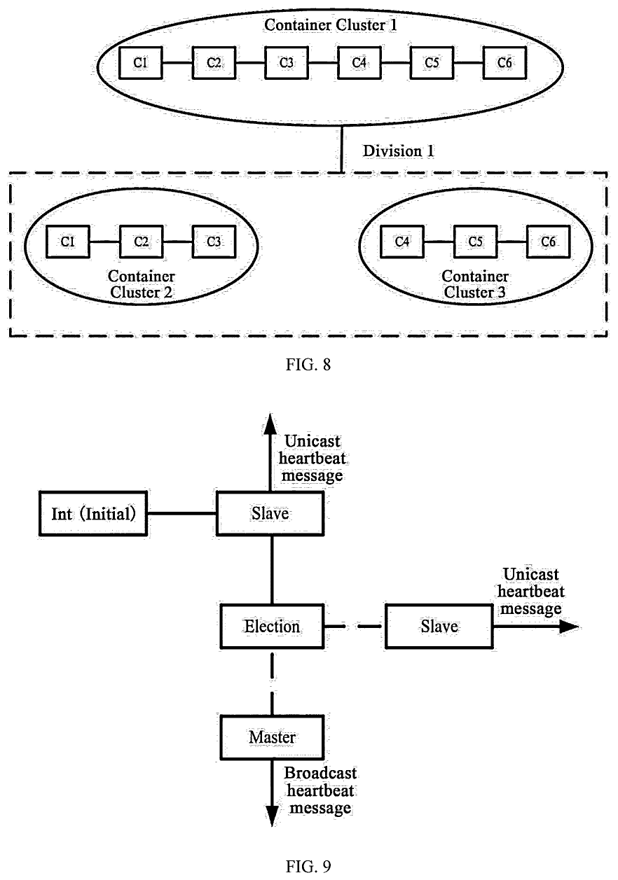

Through the flow shown in FIG. 7, it is demonstrated how to elect a master based on the container health level of the local container and the container health levels of the other containers. FIG. 8 provides a schematic representation through networking. As shown in FIG. 8, it is assumed that the initial container cluster (represented as container cluster 1) consists of C1 to C6, with C1 as the master, and due to a link abnormality between C4 and C1, the container cluster is divided into container clusters 2 and 3, where the container cluster 2 consists of C1 to C3, and the container clusters 3 consists of C4 to C6. For the container cluster 2, C1 may still serve as the master, but for the container cluster 3, in response to determining that the leader fails, C4 to C6 in the container cluster will execute the processes shown in FIG. 7. Taking C4 as an example, C4 enters the election state, and starts the election timer; and in response to determining that the container health levels of all other containers, namely C5 and C6, participating in the election, are obtained prior to the election timer times out, turns out the timer, and selects a master based on the container health level of the local container and the container health levels of the other containers, namely C5, C6. Otherwise, in response to determining that the election timer times out, a master is elected based on the container health level of the local container and the container health levels of the other containers, namely C5, C6. In response to determining that in the container health levels of C4 to C6, the health level of C4 is the largest, then C4 is elected as the master for the container cluster 3.

In this example, based on the above description, it may be seen that containers may switch between master/slave, election state, and master/slave. Taking container C4 shown in FIG. 8 as an example, FIG. 9 illustrates the schematic diagram of status switching of C4. As shown in FIG. 9, initially, C1 is the master, and C4 is the slave, and C4 sends an unicast heartbeat message to C1 for heartbeat detection. In response to determining that a faulty in C1 or in a link between C1 and C4 is detected through heartbeat detection, C4 triggers a re-election of the master. In the re-election of the master, C4 enters the election state (Election) and starts the election timer. Then, based on the container health level of C4 and the container health levels of other containers, namely C5, C6, a master is elected. In response to determining that C4 is elected as a master, C4 switches from Election to master and broadcasts a heartbeat message. In response to determining that C4 is elected as a slave and C5 is elected as a master, C4 switches from Election to slave and send a unicast heartbeat message to the newly elected master.

The following describes how to elect a master based on the leader's control in block 303:

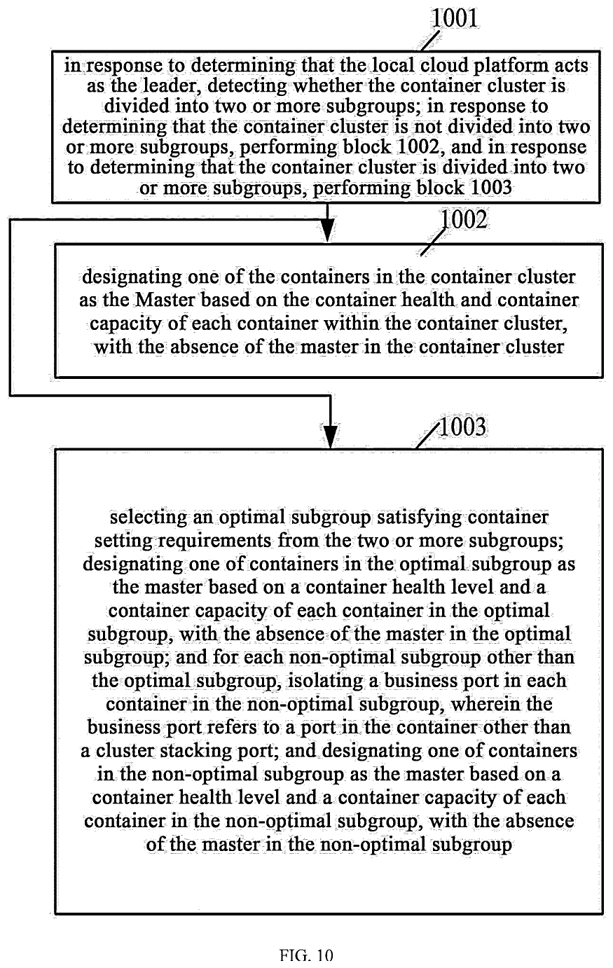

Referring to FIG. 10, FIG. 10 provides another schematic diagram for block 303 provided in an example of the present disclosure. As shown in FIG. 10, the schematic diagram may comprise the following blocks:

Block 1001, in response to determining that the local cloud platform acts as the leader, detecting whether the container cluster is divided into two or more subgroups; in response to determining that the container cluster is not divided into two or more subgroups, performing block 1002, and in response to determining that the container cluster is divided into two or more subgroups, performing block 1003.

Block 1002, designating one of containers in the container cluster as a master based on a container health level and a container capacity of each container in the container cluster, with the absence of the master in the container cluster.

Herein, one of containers in the container cluster may be designated as the master based on the following designating principles: a container with the best, i.e. largest health level, is designated as the master. In response to determining that the containers have the same container health level, a container with the largest container capacity is designated as the master.

Block 1003, selecting an optimal subgroup that meets set container requirements from the two or more subgroups; designating one of containers in the optimal subgroup as a master based on a container health level and a container capacity of each container in the optimal subgroup, with the absence of the master in the optimal subgroup; and for each non-optimal subgroup other than the optimal subgroup, isolating a business port in each container in the non-optimal subgroup, wherein the business port refers to a port in the container other than a cluster stacking port; and designating one of containers in the non-optimal subgroup as a master based on a container health level and container capacity of each container in the non-optimal subgroup, with the absence of the master in the non-optimal subgroup.

In this example, the optimal subgroup may be a subgroup with the smallest number of containers.

In this example, the designation of one of containers in the optimal subgroup as a master or the designation of one of containers in the non-optimal subgroup as a master may be performed according to the above designating principles, and will not be elaborated here.

Thus, the flow shown in FIG. 10 is completed.

Through the flow shown in FIG. 10, the election of master based on the control of the leader is achieved.

It should be noted that in this example, in response to determining that the original abnormal master recovers to be normal, it is possible to control the other non-optimal subgroups other than the optimal subgroup to restart and join the optimal subgroup, eventually recovering to the status prior to the original master's abnormality occurs.

The method provided in this example of the present disclosure is described above, and the apparatus provided in an example of the present disclosure is described below:

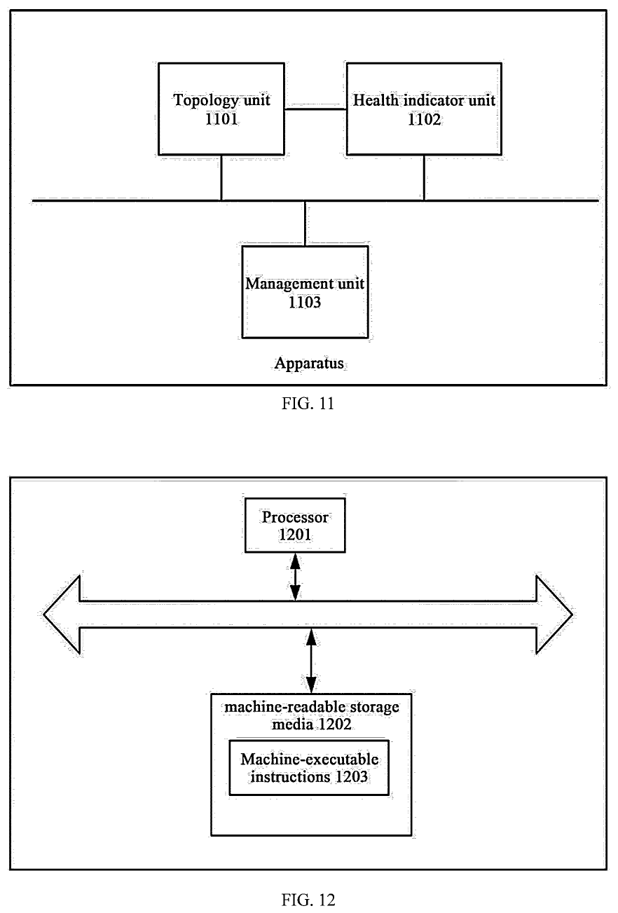

Referring to FIG. 11, FIG. 11 is a structural diagram of the apparatus provided in the example of the present disclosure. The apparatus is applied to any member apparatus in a stacked system, the stacked system is obtained by stacking N member apparatuses, each of which is deployed with both a cloud platform and a container, cloud platforms on different member apparatuses in the stacked system form a cloud platform cluster, and containers on different member apparatuses in the stacked system form a container cluster, wherein the apparatus comprises: a topology unit, which is to obtain container cluster topology information from a cloud platform that is elected as a leader in the cloud platform cluster in response to determining that a local cloud platform acts as a follower in the cloud platform cluster; sending the container cluster topology information to other member apparatuses in response to determining the local cloud platform acts as a leader; a health indicator unit, which is to, in response to determining that the local cloud platform acts as a leader, determine a container health level of a local container in the member apparatus based on a health indicator of a health status of the local container, and receive health indicators of containers reported by other member apparatuses in the stacked system, then determine container health levels of the containers on the other member apparatuses based on the received health indicators, and issue the container health levels to the other member apparatuses; a management unit, which is to, in response to determining that the local cloud platform acts as the follower, in response to determining that the local container is a slave container, slave, in the container cluster and a master container, master, election event in the container cluster is detected by the local container, then in response to determining that the leader is abnormal or a link between this container and the leader is abnormal, send an unicast election message to other containers participating in the election in the container cluster based on the container cluster topology information to obtain container health levels of the other containers, and then elect a master based on the container health level of the local container and the container health levels of the other containers; in response to determining that the leader in the cloud platform cluster is normal and the link between this container and the leader is normal, elect the master based on the control of the leader. The local container takes over the original master's tasks and notifies other slaves to stop the election as it is elected as the master (a new). The local container continues to function in the role of slave as it is elected as slave.

Optionally, the health indicator comprises: health indicators in different dimensions in a container environment, and health indicators in different dimensions a the container capacity.

The container health level is positively correlated with a container environment health level and a container capacity health level, wherein the container environment health level is determined based on the health indicators in various dimensions in the container environment, and the container capacity heath is determined based on the health indicators in various dimensions in the container capacity.

Optionally, the master election event comprises one or more of the following events: a critical component designated to the master in the container cluster fails, and a heartbeat detection timeout; wherein, the heartbeat detection is performed between the slave and master in the container cluster, and in response to determining that the slave does not receive a response from the master within the set time period, the heartbeat detection timeout is determined.

Optionally, the management unit further switches the status of the local container to the election status and starts the election timer in response to determining that the leader is abnormal or a link between this container and the leader is abnormal.

Optionally, electing the master based on the container health level of the local container and the container health levels of the other containers comprises: in response to determining that the container health levels of all of the other containers participating in the election are obtained prior to the election timer times out, turning off the election timer, and electing the master based on the container health level of the local container and the container health levels of the other containers; in response to determining that the container health levels of all of the other containers participating in the election are not obtained prior to the election timer times out, electing the master based on the container health level of the local container and the container health levels of the other containers in response to determining the election timer times out.

Optionally, electing the master based on the container health level of the local container and the container health levels of the other containers comprises: electing a container with a largest container health level from the container health level of the local container and the container health levels of the other containers; in response to determining that values of container health levels of two or more containers are the same and largest, electing a container with a longest running time from the two or more containers; in response to determining that the number of the elected containers with the longest running time is greater than 1, selecting, from the elected containers with the longest running time, a container which has a bridge MAC address meeting set requirements as the master.

Optionally, electing the master based on the control of the leader comprises: in response to determining that the local cloud platform acts as a leader, detecting whether the container cluster is divided into two or more subgroups; detecting, by the local cloud platform acting as the leader, the container cluster is not divided into two or more subgroups; designating one of the containers in the container cluster as the Master based on the container health and container capacity of each container within the container cluster, with the absence of the master in the container cluster; or detecting, by the local cloud platform acting as the leader, the container cluster is divided into two or more subgroups; selecting an optimal subgroup satisfying container setting requirements from the two or more subgroups; designating one of containers in the optimal subgroup as the master based on a container health level and a container capacity of each container in the optimal subgroup, with the absence of the master in the optimal subgroup; and for each non-optimal subgroup other than the optimal subgroup, isolating a business port in each container in the non-optimal subgroup, wherein the business port refers to a port in the container other than a cluster stacking port; and designating one of containers in the non-optimal subgroup as a master basing on a container health level and a container capacity of each container in the non-optimal subgroup, with the absence of the master in the non-optimal subgroup.

So far, the description of the apparatus shown in FIG. 11 is completed.

For the implementation processes of the functions and effects of each unit in the above apparatus, please refer to in the implementation processes of the corresponding blocks of the above method for details, and will not be repeated here.

For the apparatus example, since it basically corresponds to the method example, relevant details may be found in the explanation of the method example. The apparatus example described above is only illustrative. The modules described as separate components may or may not be physically separated, and the components displayed as modules may or may not be physical modules, i.e., they may be located in one place, or may be distributed among multiple network modules. Some or all of the modules may be selected as needed to achieve the purpose of solutions in this specification. Those skilled in the art may understand and implement the present disclosure without creative work.

Correspondingly, an example of the present disclosure further provides a hardware structural diagram of the apparatus shown in FIG. 11, as shown in FIG. 12. The electronic apparatus may be the apparatus for implementing the above method. As shown in FIG. 12, the hardware structure comprises: a processor and a machine-readable storage media, where the machine-readable storage media stores machine-executable instructions therein that may be executed by the processor; the processor is to execute the machine-executable instructions to carry out the method disclosed in the above example.

For example, the machine-readable storage media may be any electronic, magnetic, optical, or other physical storage apparatus, and may contain or store information such as executable instructions, data, and so on. For example, the machine-readable storage media may be: RAM (Random Access Memory), volatile memory, non-volatile memory, flash memory, storage drive (such as hard drive), solid-state drive, any type of storage disk (such as CD, DVD, etc.), or similar storage media, or a combination thereof.

So far, the description of the electronic apparatus shown in FIG. 12 is completed.

The above has described specific examples of the present specification. Other examples are within the scope of the appended claims. In some cases, the actions or processes recorded in the claims may be performed in a different order than in the examples and still achieve the desired result. In addition, the processes depicted in the drawings do not necessarily require specific or continuous order to achieve the desired result. In some examples, multitasking and parallel processing are further possible or may be advantageous.

After considering the present specification and practicing the invention, those skilled in the art will readily conceive of other examples of the present specification. This specification is intended to cover any modifications, uses, or adaptations of the present specification, which follow the general principles of the present specification and comprise common knowledge or conventional techniques in the technical field not applied for in the present specification. The specification and example are illustrative, and the true scope and spirit of the specification are indicated by the following claims.

It should be understood that the present specification is not limited to the precise structure described above and shown in the drawings, and various modifications and changes may be made without departing from its scope. The scope of the present specification is limited only by the appended claims.

The above is only an exemplary example of the present specification, and should not be to limit the present specification. Any modifications, equivalent substitutions, improvements, etc., made within the spirit and principle of the present specification should be comprised within the scope of the present specification.

1. A container management method based on a cloud platform applied to any member apparatus in a stacked system, the stacked system is obtained by stacking N member apparatuses, each of which is deployed with both a cloud platform and a container, cloud platforms on different member apparatuses in the stacked system form a cloud platform cluster, and containers on different member apparatuses in the stacked system form a container cluster, wherein the method comprises:
in response to determining that a local cloud platform acts as a follower in the cloud platform cluster, obtaining container cluster topology information from a cloud platform that is elected as a leader in the cloud platform cluster; in response to determining that the local cloud platform acts as the leader, sending the container cluster topology information to other member apparatuses;
with the local cloud platform acting as the leader, determining a container health level of a local container in the member apparatus based on a health indicator of a health status of the local container, and receiving health indicators of containers reported by other member apparatuses in the stacked system, then determining container health levels of the containers on the other member apparatuses based on the received health indicators, and issuing the container health levels to the other member apparatuses; or
with the local cloud platform acting as the follower, in response to determining that the local container is a slave container, slave, in the container cluster and a master container, master, election event in the container cluster is detected by the local container, then in response to determining that the leader or a link between this container and the leader is abnormal, sending an unicast election message to other containers participating in the election in the container cluster based on the container cluster topology information to obtain container health levels of the other containers, and then electing a master based on the container health level of the local container and the container health levels of the other containers; in response to determining that the leader in the cloud platform cluster is normal and the link between this container and the leader is normal, electing the master based on the leader's control, wherein in response to determining that the local container is elected as the master, the local container takes over an original master's work and notifies other slaves to stop the election, and in response to determining that the local container is elected as the slave, the local container continues to work as the slave.

2. The method according to claim 1, wherein the health indicator comprises health indicators in multiple different dimensions in a container environment and health indicators in multiple different dimensions in a container capacity, and
the container health level is positively correlated with a container environment health level and a container capacity health level, wherein the container environment health level is determined based on the health indicators in various dimensions in the container environment, and the container capacity health level is determined based on the health indicators in various dimensions in the container capacity.

3. The method according to claim 1, wherein in response to determining that the leader is abnormal or the link between this container and the leader is abnormal, the method further comprises switching a status of the local container to an election state and starting an election timer, and
electing the master based on the container health level of the local container and the container health levels of the other containers, comprises:
in response to determining that container health levels of all of the other containers participating in the election are obtained prior to the election timer times out, turning off the election timer and electing the master based on the container health level of the local container and the container health levels of the other containers; otherwise, electing the master based on the container health level of the local container and the container health levels of the other containers in response to determining that the election timer times out.

4. The method according to claim 1, wherein electing the master based on the container health level of the local container and the container health levels of the other containers comprises:
electing a container with a largest container health level from the container health level of the local container and the container health levels of the other containers;
in response to determining that values of container health levels of two or more containers are the same and largest, electing a container with a longest running time from the two or more containers; and
in response to determining that the number of the elected containers with the longest running time elected is greater than one, selecting, from the elected containers with the longest running time, a container which has a bridge MAC address meeting set requirements as the master.

5. The method according to claim 3, wherein electing the master based on the container health level of the local container and the container health levels of the other containers comprises:
electing a container with a largest container health level from the container health level of the local container and the container health levels of the other containers;
in response to determining that values of container health levels of two or more containers are the same and largest, electing a container with a longest running time from the two or more containers; and
in response to determining that the number of the elected containers with the longest running time elected is greater than one, selecting, from the elected containers with the longest running time, a container which has a bridge MAC address meeting set requirements as the master.

6. The method according to claim 1, wherein electing the master based on the leader's control comprises:
detecting, by the local cloud platform acting as the leader, the container cluster is not divided into two or more subgroups; designating one of the containers in the container cluster as the Master based on the container health and container capacity of each container within the container cluster, with the absence of the master in the container cluster; or
detecting, by the local cloud platform acting as the leader, the container cluster is divided into two or more subgroups; selecting an optimal subgroup satisfying container setting requirements from the two or more subgroups; designating one of containers in the optimal subgroup as the master based on a container health level and a container capacity of each container in the optimal subgroup, with the absence of the master in the optimal subgroup; and for each non-optimal subgroup other than the optimal subgroup, isolating a business port in each container in the non-optimal subgroup, wherein the business port refers to a port in the container other than a cluster stacking port; and designating one of containers in the non-optimal subgroup as the master based on a container health level and a container capacity of each container in the non-optimal subgroup, with the absence of the master in the non-optimal subgroup.

7. A container management apparatus based on a cloud platform, which is applied to any member apparatus in a stacked system, the stacked system is obtained by stacking N member apparatuses, each of which is deployed with both a cloud platform and a container, cloud platforms on different member apparatuses in the stacked system form a cloud platform cluster, and containers on different member apparatuses in the stacked system form a container cluster, wherein the apparatus comprises:
a topology unit, which is to obtain container cluster topology information from a cloud platform that is elected as a leader in the cloud platform cluster in response to determining that a local cloud platform acts as a follower in the cloud platform cluster, and send the container cluster topology information to other member apparatuses in response to determining that the local cloud platform acts as the leader;
a health indicator unit, which is to, with the local cloud platform acting as the leader, determine a container health level of a local container in the member apparatus based on a health indicator of a health status of the local container, and receive health indicators of containers reported by other member apparatuses in the stacked system, then determine container health levels of the containers on the other member apparatuses based on the received health indicators, and issue the container health levels to the other member apparatuses; and
a management unit, which is to, with the local cloud platform acting as the follower, in response to determining that the local container is a slave container, slave, in the container cluster and a master container, master, election event in the container cluster is detected by the local container, then in response to determining that the leader or a link between this container and the leader is abnormal, send an unicast election message to other containers participating in the election in the container cluster based on the container cluster topology information to obtain container health levels of the other containers, and then elect a master based on the container health level of the local container and the container health levels of the other containers; in response to determining that the leader in the cloud platform cluster is normal and the link between this container and the leader is normal, elect the master based on the leader's control, wherein in response to determining that the local container is elected as the master, the local container takes over an original master's work and notifies other slaves to stop the election, and in response to determining that the local container is elected as the slave, the local container continues to work as the slave.

8. The apparatus according to claim 7, wherein the health indicator comprises:
health indicators in multiple different dimensions in a container environment, and health indicators in multiple different dimensions in a container capacity; and
the container health level is positively correlated with a container environment health level and a container capacity health level, wherein the container environment health level is determined based on the health indicators in various dimensions in the container environment, and the container capacity health level is determined based on the health indicators in various dimensions in the container capacity.

9. The apparatus according to claim 7, wherein the management unit further switches a status of the local container to an election state and starts an election timer in response to determining that the leader is abnormal or the link between this container and the leader is abnormal, and
electing the master based on the container health level of the local container and the container health levels of the other containers comprises:
in response to determining that container health levels of all of the other containers participating in the election are obtained prior to the election timer times out, turning off the election timer, and electing the master based on the container health level of the local container and the container health levels of the other containers; in response to determining that the container health levels of all of the other containers participating in the election are not obtained prior to the election timer times out, electing the master based on the container health level of the local container and the container health levels of the other containers in response to determining that the election timer times out.

10. The apparatus according to claim 7, wherein electing the master based on the container health level of the local container and the container health levels of the other containers comprises:
electing a container with a largest container health level from the container health level of the local container and the container health levels of the other containers;
in response to determining that values of container health levels of two or more containers are the same and largest, electing a container with a longest running time from the two or more containers; and
in response to determining that the number of the elected containers with the longest running time is greater than one, selecting, from the elected containers with the longest running time, a container which has a bridge MAC address meeting set requirements as the master.

11. The apparatus according to claim 9, wherein electing the master based on the container health level of the local container and the container health levels of the other containers comprises:
electing a container with a largest container health level from the container health level of the local container and the container health levels of the other containers;
in response to determining that values of container health levels of two or more containers are the same and largest, electing a container with a longest running time from the two or more containers; and
in response to determining that the number of the elected containers with the longest running time is greater than one, selecting, from the elected containers with the longest running time, a container which has a bridge MAC address meeting set requirements as the master.

12. The apparatus according to claim 7, wherein electing the master based on the leader's control comprises:
detecting, by the local cloud platform acting as the leader, the container cluster is not divided into two or more subgroups; designating one of the containers in the container cluster as the Master based on the container health and container capacity of each container within the container cluster, with the absence of the master in the container cluster; or
detecting, by the local cloud platform acting as the leader, the container cluster is divided into two or more subgroups; selecting an optimal subgroup satisfying container setting requirements from the two or more subgroups; designating one of containers in the optimal subgroup as the master based on a container health level and a container capacity of each container in the optimal subgroup, with the absence of the master in the optimal subgroup; and for each non-optimal subgroup other than the optimal subgroup, isolating a business port in each container in the non-optimal subgroup, wherein the business port refers to a port in the container other than a cluster stacking port; and designating one of containers in the non-optimal subgroup as a master based on a container health level and a container capacity of each container in the non-optimal subgroup, with the absence of the master in the non-optimal subgroup.
